(19) United States
(12) Patent Application Publication
(10) Pub. No.: US 2013/0157674 A1
(43) Pub. Date: Jun. 20, 2013

(54) BANDWIDTH EXTENSION USAGE OPTIMIZATION

(71) Applicants: Markku Juhani Jylha-Ollila, Helsinki (FI); Olli Sakari Kirla, Espoo (FI); Robert Tenczer, Budapest (HU)

(72) Inventors: Markku Juhani Jylha-Ollila, Helsinki (FI); Olli Sakari Kirla, Espoo (FI); Robert Tenczer, Budapest (HU)

(73) Assignee: NOKIA SIEMENS NETWORKS OY, ESPOO (FI)

(21) Appl. No.: 13/637,039

(22) PCT Filed: Mar. 25, 2010
(86) PCT No.: PCT/EP2010/053906

§ 371 Date: Dec. 12, 2012

(51) Int. Cl. H04W 28/22

(52) U.S. Cl. CPC H04W 28/22
USPC 455/450

(57) ABSTRACT

An apparatus, method, system and computer program product is configured for optimizing usage of bandwidth extension. Codecs to be used in a communication connection between communication network nodes are negotiated. The negotiating includes indicating a capability of a communication network node to expand bandwidth by indicating support of the communication network node for a wideband codec towards another communication network node; and indicating a lack of codec transparency for the wideband codec at the communication network node.

### FIELD OF THE INVENTION

The present invention relates to an apparatus, method, system and computer program product for optimizing usage of bandwidth extension. In particular, the present invention relates to an apparatus, method, system and computer program product for optimizing usage of bandwidth extension in a mobile services switching center server system (MSS).

### RELATED BACKGROUND ART

Prior art which is related to this technical field can e.g. be found by the technical specifications TS 23.153 current version: 9.0.0) of the 3GPP.

The following meanings for the abbreviations used in this specification apply:
2G: 2^{nd} Generation Standard (e.g. GSM)
3G: 3rd Generation Standard (e.g. UMTS)
3GPP: 3^{rd} Generation Partnership Project
ABE: Adaptive/Artificial Bandwidth Extension
ACL: Available Codecs List
AMR: Adaptive Multi-Rate
ARPU: Average Revenue per User
BICC: Bearer Independent Call Control
BSS: Base Station Subsystem
BWE: Bandwidth Extension
DECT: Digital Enhanced Cordless Telecommunications
DSP: Digital Signal Processor
EVRC: Enhanced Variable Rate Codec
GSM: Global System for Mobile Communication
HD: High Definition
IMEI: International Mobile Station Equipment Identity
IMEISV: IMEI and Software Version Number
IMS: IP Multimedia Subsystem
IP: Internet Protocol
ISDN: Integrated Services Digital Network
ISUP: ISDN User Part
ITU: International Telecommunication Union
ITU-T: ITU Telecommunication Standardization Sector
LTE: Long Term Evolution
MCCN: Mid Call Codec Negotiation
MGW: Multimedia Gateway
MS: Mobile Station
MSC: Mobile Services Switching Center
MSS: MSC Server System
NB: Narrowband
PCM: Pulse Code Modulation
PSTN: Public Switched Telephone Network
SAA: Service Attribute Analysis
SC: Selected Codec
SCL: Supported Codecs List
SIP: Session Initiation Protocol
SIP-I: SIP with encapsulated ISUP
TAC: Type Allocation Code
TISPAN: Telecommunications and Internet converged
Services and Protocols for Advanced Networking
TrFO: Transcoder free Operation
TFO: Tandem free Operation
UE: User Equipment
UMTS: Universal Mobile Telecommunications System
VoIP: Voice over IP
WB: Wideband

Recently, an important feature in cellular networks became the introduction of high definition voice which enables a new level of voice experience for the end users. Some operators have already publicly announced the deployment of HD voice and many other major operators are presently in a process completing their acceptance testing for HD voice in their networks.

HD voice is also termed wideband speech in mobile or fixed networks, and a problem to solve in introducing HD voice are narrow-band-to-wideband inter-working scenarios where one terminal is wideband capable but the other one is only narrow-band capable.

One solution to enable wideband speech for wideband capable terminals users when the other party is using a narrow-band terminal or service is called bandwidth extension (BWE). Synonymous to bandwidth extension, it is sometimes referred to adaptive bandwidth extension (ABE) or artificial bandwidth expansion (ABE). BWE generates missing higher frequency band speech signals in a sophisticated manner from the received narrow-band speech. BWE can be used either in a terminal after a narrow-band speech decoder, or in the network before a wideband encoder, i.e. in the first case an NB codec will be allocated to the terminal, and in the latter case a WB codec, respectively.

Wideband speech is a very attractive feature for operators, because it will likely reduce churn and it will increase call times and thus ARPU. This is due to much better user experience which results from better voice quality and intelligibility. Major mobile network and terminal vendors can now offer a wideband speech solution which is based on AMR-WB speech codec. Therefore, many operators are very keen on wideband speech at the moment.

Thus, BWE will make HD voice even more attractive as it will always provide wideband experience even when the subscriber is connected to a narrow-band service. This is a very likely scenario when WB terminal penetration is low. For example, if the WB terminal penetration is 10%, without using BWE, only 1% of calls will be established as WB calls and 18% of calls to WB or from WB terminal will end up as conventional NB calls. Consequently, 18/19%=95% of calls for WB terminal users will end up as an NB call. In the case of BWE, however, all these NB calls will be effectively WB calls, and thus all WB terminal users will have a WB experience.

Accordingly, an advantage of BWE lies in the fact that it can provide the HD like voice experience for all end users that have a HD enabled terminal, while current standard HD voice solutions always require two HD voice enabled terminals to work.

### SUMMARY OF THE INVENTION

It is an object of the present invention to further improve the concept of providing wideband speech.

According to a first aspect of the present invention, this is accomplished by an apparatus, comprising codec negotiation means configured to negotiate codecs to be used in a communication connection between communication network nodes, and to indicate, in negotiation, a capability of a communication network node to expand bandwidth by indicating support of the communication network node for a wideband codec towards another communication network node, and indicating lacking codec transparency for the wideband codec at the communication network node.

Modifications of the first aspect may be as follows.

The apparatus according to the first aspect may be configured to be suitable for optimizing usage of bandwidth extension.

The codec negotiation means can be further configured to indicate the capability of a communication network node to expand bandwidth by further indicating the capability of the communication network node to provide narrowband-wideband transcoding.

The codec negotiation means can be further configured to indicate the support of the communication network node for a wideband codec towards another communication network node and the lacking codec transparency for the wideband codec at the communication network node by including the wideband codec in a category of indirect codecs in a codec negotiation list for use in a communication node codec negotiation.

The codec negotiation means can be further configured to indicate the capability of the communication network node to provide narrowband-wideband transcoding by at the same time including the wideband codec in a category of indirect codecs and including a narrowband codec in a category of direct codecs in a codec negotiation list for use in a communication node codec negotiation.

According to a second aspect of the present invention, the object is accomplished by an apparatus, comprising a codec negotiation processor configured to negotiate codecs to be used in a communication connection between communication network nodes, and to indicate, in negotiation, a capability of a communication network node to expand bandwidth by indicating support of the communication network node for a wideband codec towards another communication network node, and indicating lacking codec transparency for the wideband codec at the communication network node.

Modifications of the second aspect of the present invention may correspond to the modifications of the first aspect.

According to a third aspect of the present invention, the object is accomplished by an apparatus, comprising detection means configured to detect via an interface connection a capability of a terminal to expand bandwidth.

Modifications of the third aspect may be as follows.

The apparatus according to the third aspect may be configured to be suitable for optimizing usage of bandwidth extension.

The detection means can be further configured to detect the international mobile station equipment identity of the terminal and to identify a bandwidth expansion capability of the terminal based on a look-up table listing international mobile station equipment identities corresponding to a bandwidth expansion capability.

The apparatus can further comprise codec negotiation means configured to negotiate codecs to be used in a communication connection between communication network nodes; and bandwidth expansion capability activation means configured to activate a bandwidth expansion capability.

For responding to the detection means detecting a terminal having bandwidth expansion capability in the communication connection for which a codec is to be negotiated, the codec negotiation means can be further configured to perform a narrowband codec selection process for the communication connection, and the bandwidth expansion capability activation means can be further configured to activate the bandwidth expansion capability in the terminal.

For responding to the detection means detecting a terminal having bandwidth expansion capability in the communication connection for which a codec is to be negotiated, the codec negotiation means can be further configured to perform a codec modification process which modifies a wideband codec as the negotiated codec to a narrowband codec as the negotiated codec, and the bandwidth expansion capability activation means can be further configured to activate the bandwidth expansion capability in the terminal.

For responding to the detection means detecting a terminal not having bandwidth expansion capability or having insufficient bandwidth expansion capability in the communication connection for which a codec is to be negotiated, the codec negotiation means can be further configured to perform a wideband codec selection process for the communication connection, and the bandwidth expansion capability activation means can be further configured to activate the bandwidth expansion capability in a communication network node.

According to a fourth aspect of the present invention, the object is accomplished by an apparatus, comprising a detection processor configured to detect via an interface connection a capability of a terminal to expand bandwidth.

Modifications of the fourth aspect of the present invention may correspond to the modifications of the third aspect.

According to a fifth aspect of the present invention, the object is accomplished by a mobile services switching center server system comprising an apparatus according to any one of the first to fourth aspects.

According to a sixth aspect of the present invention, the object is accomplished by a communication node system comprising an apparatus according to the first or second aspect and any of their respective modifications and an apparatus according to the third or fourth aspect and any of their respective modifications.

According to a seventh aspect of the present invention, the object is accomplished by a method, comprising negotiating codecs to be used in a communication connection between communication network nodes, wherein the negotiating comprises indicating a capability of a communication network node to expand bandwidth by indicating support of the communication network node for a wideband codec towards another communication network node; and indicating lacking codec transparency for the wideband codec at the communication network node.

Modifications of the seventh aspect may be as follows.

The method according to the seventh aspect may be configured to be suitable for optimizing usage of bandwidth extension.

The negotiating can further comprise indicating the capability of a communication network node to expand bandwidth by further indicating a capability of the communication network node to provide narrowband-wideband transcoding.

The negotiating can further comprise indicating the support of the communication network node for a wideband codec towards another communication network node and the lacking codec transparency for the wideband codec at the communication network node by including the wideband codec in a category of indirect codecs in a codec negotiation list for use in a communication node codec negotiation.

The negotiating can further comprise indicating the capability of the communication network node to provide narrowband-wideband transcoding by at the same time including the wideband codec in a category of indirect codecs and including a narrowband codec in a category of direct codecs in a codec negotiation list for use in a communication node codec negotiation.

The method according to the seventh aspect or any of its modifications may be performed by the apparatus according to the first or second aspect or suitable ones of their modifications.

According to an eighth aspect of the present invention, the object is accomplished by a method, comprising detecting via an interface connection whether a terminal has capability to expand bandwidth.

Modifications of the eighth aspect may be as follows.

The method according to the eighth aspect may be configured to be suitable for optimizing usage of bandwidth extension.

The detecting can further comprise detecting the international mobile station equipment identity of the terminal and identifying a bandwidth expansion capability of the terminal based on a look-up table listing international mobile station equipment identities corresponding to a bandwidth expansion capability.

The method can further comprise negotiating codecs to be used in a communication connection between communication network nodes; and activating a bandwidth expansion capability.

The method can further comprise responding to detecting a terminal having bandwidth expansion capability in the communication connection by performing a narrowband codec selection process for the communication connection, and activating the bandwidth expansion capability in the terminal.

The method can further comprise responding to detecting a terminal having bandwidth expansion capability in the communication connection by performing a codec modification process which modifies a wideband codec as the negotiated codec to a narrowband codec as the negotiated codec, and activating the bandwidth expansion capability in the terminal.

The method can further comprise responding to detecting a terminal not having bandwidth expansion capability or having insufficient bandwidth expansion capability in the communication connection by performing a wideband codec selection process for the communication connection, and activating the bandwidth expansion capability in a communication network node.

The method according to the eighth aspect or any of its modifications may be performed by the apparatus according to the third or fourth aspect or suitable ones of their modifications.

According to a ninth aspect of the present invention, the object is accomplished by a computer program product comprising computer-executable components which perform, when the program is run on a computer, negotiating codecs to be used in a communication connection between communication network nodes, wherein the negotiating comprises indicating a capability of a communication network node to expand bandwidth by indicating support of the communication network node for a wideband codec towards another communication network node; and indicating lacking codec transparency for the wideband codec at the communication network node.

Modifications of the ninth aspect may be as follows.

The computer program product according to the ninth aspect may be suitable for optimizing usage of bandwidth extension.

The computer program product according to the ninth aspect may be embodied as a computer-readable storage medium.

Otherwise, modifications of the ninth aspect may correspond to the modifications of the seventh aspect.

According to a tenth aspect of the present invention, the object is accomplished by a computer program product comprising computer-executable components which perform, when the program is run on a computer, detecting via an interface connection whether a terminal has capability to expand bandwidth.

Modifications of the tenth aspect may be as follows.

The computer program product according to the tenth aspect may be suitable for optimizing usage of bandwidth extension.

The computer program product according to the tenth aspect may be embodied as a computer-readable storage medium.

Otherwise, modifications of the tenth aspect may correspond to the modifications of the eighth aspect.

It is to be understood that any of the above modifications can be applied singly or in combination to the respective aspects to which they refer, unless they are explicitly stated as excluding alternatives. Moreover, the first and third aspect and their respective modifications, and the second and fourth aspect and their respective modifications, respectively, can be combined.

### BRIEF DESCRIPTION OF THE DRAWINGS

The above and other objects, features, details and advantages will become more fully apparent from the following detailed description of the preferred embodiments which is to be taken in conjunction with the appended drawings, in which:

FIG. 1 shows a current BWE deployment as a comparative example 1;

FIG. 2 shows a supplementary service or handover in a current BWE deployment as a comparative example 2;

FIG. 3 shows BWE deployment according to an example 1 of the present invention;

FIG. 4 shows a supplementary service or handover and BWE according to an example 2 of the present invention;

FIG. 5 shows a PSTN originated call and BWE location in a current BWE deployment according to a comparative example 3;

FIG. 6 shows a PSTN originated call and BWE location according to an example 3 of the present invention;

FIG. 7 shows a 2G originated AMR-WB call as a comparative example 4, where BWE cannot be used with the current deployment plans and a narrow band codec is selected;

FIG. 8 shows a 2G originated AMR-WB call according to an example 4 of the present invention, where BWE is used;

FIG. 9 shows an IMEI based BWE control according to certain embodiments of the present invention;

FIG. 10 shows en example for decision logic of BWE IMEI control according to certain embodiments of the present invention;

FIG. 11 shows an example for an apparatus 1 and an apparatus 2 according to certain embodiments of the present invention; and

FIG. 12 shows a flow chart illustrating a method according to certain embodiments of the present invention.

### DETAILED DESCRIPTION OF THE PREFERRED EMBODIMENTS

In the following, description is made to what are presently considered to be preferred embodiments of the present invention. It is to be understood, however, that the description is given by way of example only, and that the described embodiments are by no means to be understood as limiting the present invention thereto.

For example, for illustration purposes, in some of the following exemplary embodiments, BWE usage optimization in cellular communication networks as e.g. based on 3GPP 2G/3G is described. However, it should be appreciated that these exemplary embodiments are not limited for use among these particular types of wireless communication systems, and according to further exemplary embodiments, the present invention can be applied also to other types of communication systems and access networks in which the wideband speech feature is to be implemented and optimized.

That is, the present invention is not limited to 3GPP 2G/3G, but is generally applicable to other communication systems such as, but not exclusively, VoIP, IMS or LTE.

Thus, certain embodiments of the present invention relate to mobile wireless communication systems, such as 3GPP 2G/3G. In more detail, certain embodiments of the present invention are related to the configuration of an MSS and components thereof, or the like.

However, as indicated above, the present invention is not limited to MSS, but other embodiments of the present invention are related to switching network nodes and components thereof.

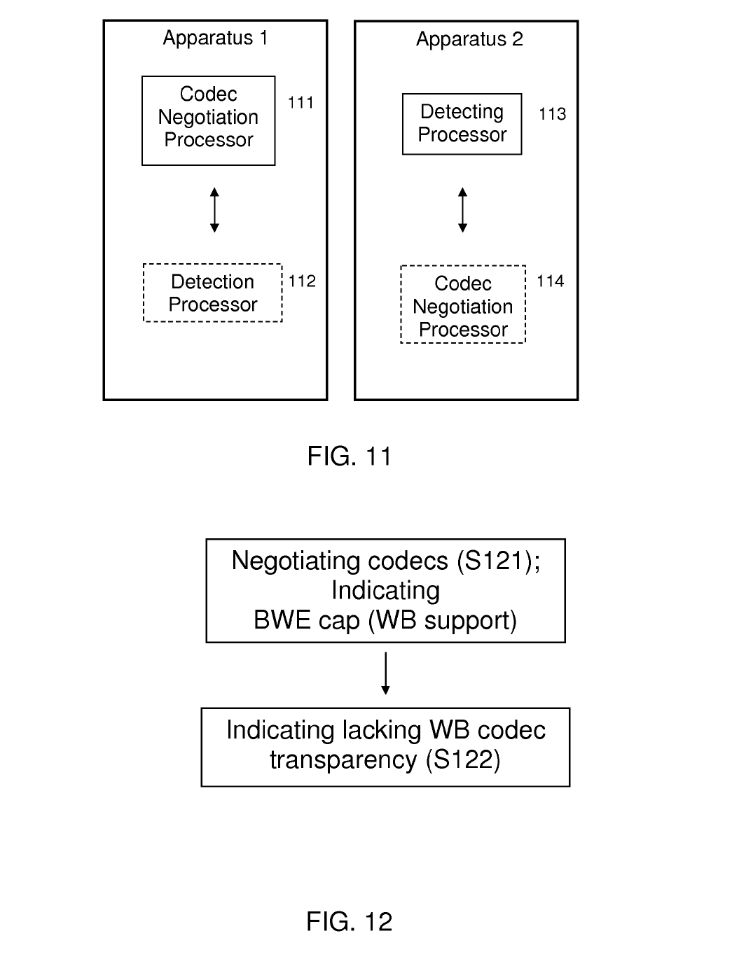

FIG. 11 shows a principle configuration of an example for an apparatus 1 according to certain embodiments of the present invention. One option for implementing this example for an apparatus according to certain embodiments of the present invention would be a component in a MSS according to 3GPP.

Specifically, as shown in FIG. 11, the example for an apparatus 1 comprises a codec negotiation processor 111 configured to negotiate codecs to be used in a communication connection between communication network nodes, and to indicate, in negotiation, a capability of a communication network node to expand bandwidth by indicating support of the communication network node for a wideband codec towards another communication network node, and indicating lacking codec transparency for the wideband codec at the communication network node.

FIG. 11 further shows a principle configuration of an example for an apparatus 2 according to certain embodiments of the present invention. One option for implementing this example for an apparatus according to certain embodiments of the present invention would be a component in a MSS according to LTE.

Specifically, as shown in FIG. 11, the example for an apparatus 2 comprises detection processor 113 configured to detect via an interface connection a capability of a terminal to expand bandwidth.

As further indicated in FIG. 11, apparatus 1 may optionally comprise a detection processor 112 so as to include the functionality of apparatus 2, or vice versa, apparatus 2 may optionally comprise a codec negotiation processor 114 so as to include the functionality of apparatus 1. Further alternatives to such modifications of apparatuses 1 and 2 may become further apparent from the below detailed description of certain further embodiments of the present invention.

FIG. 12 shows a principle flowchart of an example for a method according to certain embodiments of the present invention. That is, as shown in FIG. 12, this method comprises negotiating (S121) codecs to be used in a communication connection between communication network nodes, wherein the negotiating comprises indicating a capability of a communication network node to expand bandwidth by indicating support of the communication network node for a wideband codec towards another communication network node; and indicating (S122) lacking codec transparency for the wideband codec at the communication network node.

One option for performing the example of a method according to certain embodiments of the present invention would be to use the apparatus 1 as described above or a modification thereof which becomes apparent from the embodiments as described herein below.

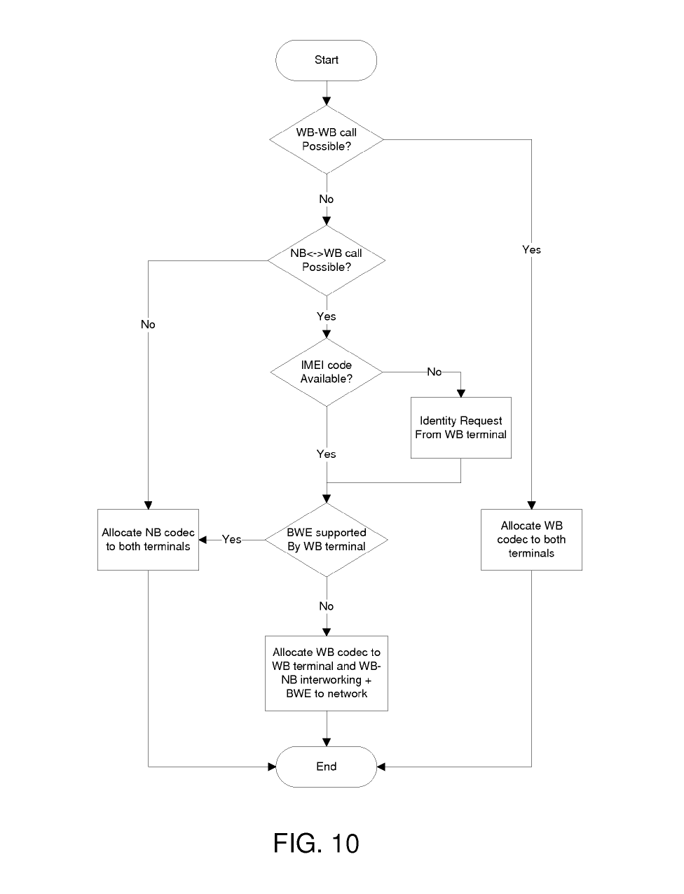

FIG. 10 shows a principle flowchart of an example for another method according to certain embodiments of the present invention. That is, as shown in FIG. 10, this method comprises determining whether BWE is supported by WB terminal as an example for detecting via an interface connection whether a terminal has capability to expand bandwidth.

Further details of FIG. 10 are described further below.

One option for performing the example of another method according to certain embodiments of the present invention would be to use the apparatus 2 as described above or a modification thereof which becomes apparent from the embodiments as described herein below.

Certain embodiments of the present invention are described herein below in further detail. Reference is made to examples and comparative examples, wherein the comparative examples refer to deployments as currently planned, while the example depict certain embodiments of the present invention. It is to be noted though, that the examples are provided for illustrative purposes and are not intended to be understood as limiting the invention thereto. Rather, it is to be understood that the feature of the examples may be interchanged and mixed as will be understood from the whole of the present specification.

When BWE is deployed as currently planned it will always reside in the access MGW to which the WB capable terminal is connected. This has the following drawbacks:
Supplementary services like late call forwarding to a mobile or PSTN in another MSS can lead to a situation where BWE and several transcodings are in cascade which deteriorates the speech quality.
Inter MSS handovers to 2G can lead to BWE and several transcodings in cascade which also deteriorates the speech quality.
BWE cannot be offered to 2G calls which harms the overall attractiveness of BWE.

Hence, the best location for BWE depends on the call configuration and is not static but changes depending on the mobility events (call forwarding, call termination, handovers and the like). Currently, there is no flexibility to locate the BWE functionality optimally at MSS system which easily leads to a situation where BWE and transcodings are cascaded. As indicated, this can deteriorate the speech quality.

According to certain embodiments of the present invention a concept is utilized where speech codecs are grouped into two categories: direct and indirect codecs, based on whether the codec can or cannot provide local codec transparency. Local codec transparency refers to a situation where the codec used by the node in question can be used on both ingress and egress side of the node without transcoding at the node. This can be accomplished either by TrFO or TFO. For instance an MSS/MGW can provide codec transparency for a wideband codec such as e.g. AMR-WB in a 2G-3G call when AMR TFO and TrFO are used.

All codecs that provide local codec transparency either via TrFO or TFO are grouped to direct codecs, and other codecs supported locally but not providing local codec transparency are included to indirect codecs.

Currently, this principle is utilized by the SIP-I protocol that is used in the Nc interface. The same principle is planned for BICC signaling. The direct codecs and indirect codecs are separated by the PCM codec G.711 (according to ITU-T recommendation) as defined in the specification 3GPP TS 23.153 (v9.0.0) chapter 9.7 “Codec Lists Structure”.

According to certain embodiments of the present invention the means are provided to convey BWE capability in a standard codec negotiation which enables the optimal location of the BWE functionality in all call configurations. When BWE is supported by MGW and MSS, and codec negotiation is used in the network BWE capability, it is signaled to the remote end by including a WB codec such as AMR-WB codec (or such as G.722, G.729.1 and EVRC-WB or other wideband codecs recommended by TISPAN in VoIP calls) in the indirect codec category.

It is to be understood that any existing codec listed in this specification serves only to provide an implementation example and to illustrate certain embodiments of the present invention. However, it is to be understood that other wideband and narrowband codecs can be used within the teaching of the present invention.

Currently, AMR-WB is only used in the codec negotiation when the local side supports AMR-WB and can provide local codec transparency for it.

According to certain embodiments of the present invention the local side that cannot provide codec transparency with e.g. AMR-WB (or e.g. G.722 in VoIP calls) but supports BWE and additionally can provide narrowband-wideband transcoding will always include e.g. AMR-WB (or e.g. G.722 in VoIP calls) as an indirect codec in the codec negotiation with the remote end, although AMR-WB does not provide local codec transparency.

Certain embodiments of the present invention are described below in further detail by referring to certain use cases in current deployment (comparative examples) and according to certain embodiments of the present invention (examples).

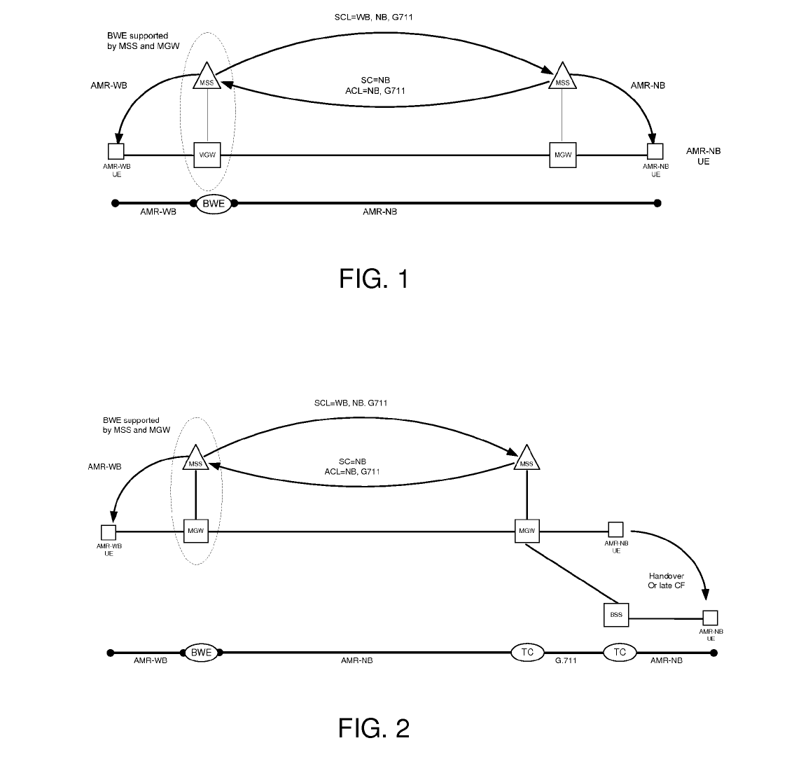

FIG. 1 shows as a comparative example 1 a 3G-3G call where BWE is used in the way as it is currently planned. The BWE functionality is active in the MGW that is the access MGW for the AMR-WB capable UE. The codec negotiation is made in a normal way and the rest of the call leg towards the called party is a TrFO call with AMR-NB.

Now if the called party undergoes a mobility event like handover or late call forwarding to 2G where no AMR-WB is supported the call will eventually have two narrow band transcodings in the call and additionally an BWE functionality on the calling party side, as shown in FIG. 2 as a comparative example 2.

FIG. 2 reveals the downside of placing the BWE statically on the access side where the AMR-WB capable UE is connected. If either late call forwarding or handover occurs on the terminating side and additional narrowband transcoding are made in the call, the speech quality will be impaired and the cascading of BWE and transcodings cannot be avoided.

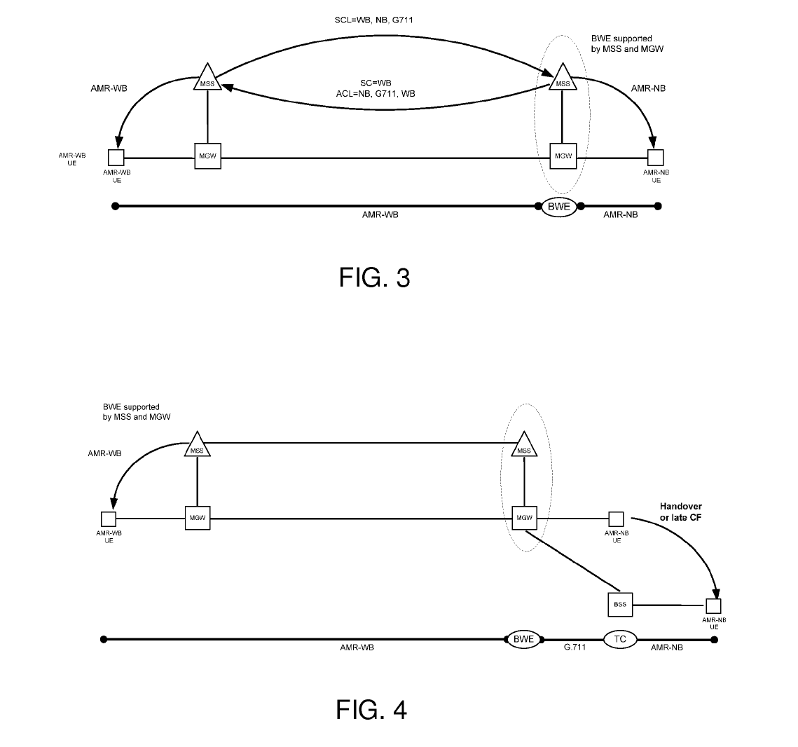

FIG. 3 shows the same call example as example 1 according to certain embodiments of the present invention.

According to FIG. 3 BWE functionality has been negotiated to the terminating side and the codec negotiation illustrates an exemplary manner to implement the invention. The calling side creates a standard supported codecs list (SCL) and includes AMR-WB as the preferred codec in the SCL before G.711, i.e. places AMR-WB to the direct codec category and indicates to the remote side that AMR-WB local codec transparency is possible. The remote side checks the local support for the BWE and selects the AMR-WB codec for the call towards the calling party and AMR-NB towards the called party. Finally, selected codec (SC) and available codecs list (ACL) are sent to the calling side. AMR-WB is included in the ACL in the indirect codecs part as AMR-WB does not provide local codec transparency on the terminating side, but indicates the support for BWE.

Now if the late call forwarding or handover occurs in the call similar to comparative example 2, the BWE functionality is optimally located at the target radio access as shown by FIG. 4, illustrating example 2.

In FIG. 4 the BWE is located in its optimal place where local codec transparency for AMR-WB cannot anymore be provided, but BWE and AMR-WB-narrowband transcoding is locally supported. This way the additional narrowband transcoding between G.711 and AMR-NB of comparative example 2 can be eliminated. If the late call forwarding or handover occurred to another MSS, then the codec negotiation would extend the AMR-WB and the BWE functionality to the target MSS/MGW, again to the optimal place.

Another example where the location of BWE must be optimized according to the call configuration is the common mobile to/from PSTN call case.

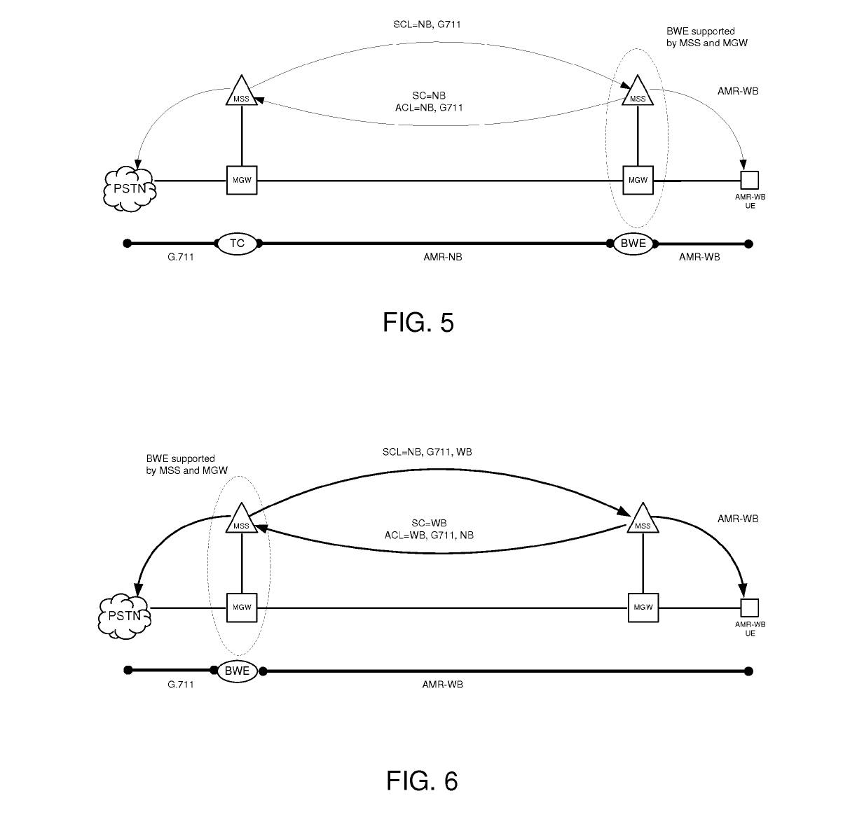

FIG. 5 shows the PSTN originated call to a mobile that supports AMR-WB according to comparative example 3, i.e. the BWE is located in the access MGW as planned by current deployment.

As can be seen from FIG. 5 the location of BWE is by no means optimal because three different codecs are used in the call and BWE is cascaded with one additional transcoding.

However, by deploying certain embodiments of the present invention the BWE location is optimized to the PSTN interface and only two codecs are used in the call, and the additional transcoding between G.711 and AMR-NB can be avoided. This is shown in FIG. 6 as example 3.

In FIG. 6 the PSTN interface MSS finds out that BWE is locally supported and indicates this in the codec negotiation by adding AMR-WB to the SCL as an indirect codec. This SCL is received by the terminating side MSS which provides local codec transparency for the AMR-WB and selects it both towards the UE and towards the MSS/MGW at the PSTN interface.

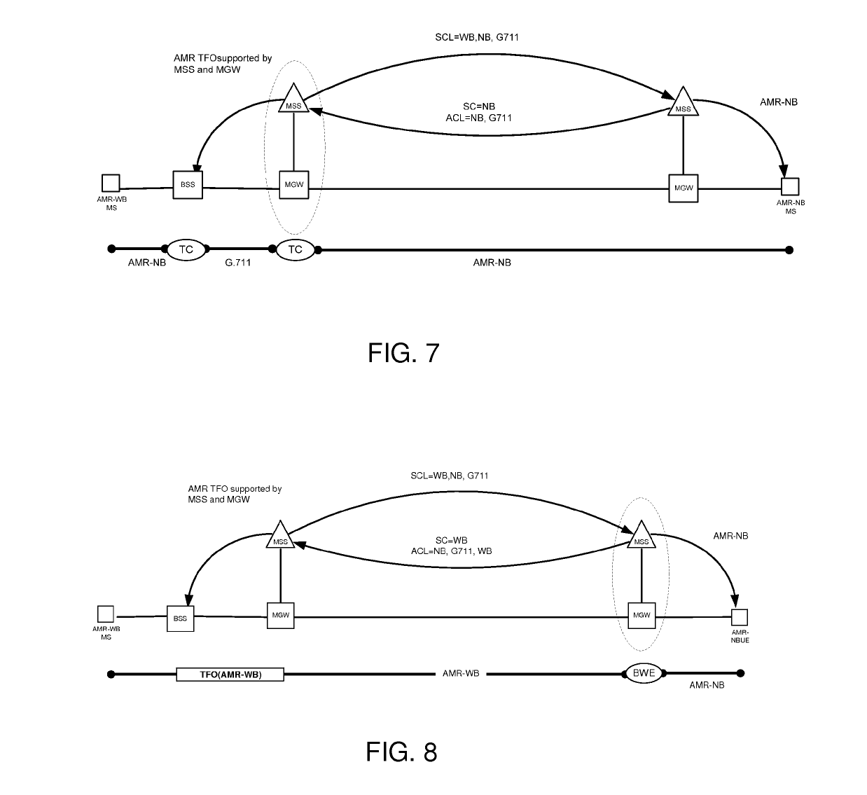

Another shortcoming of the current BWE deployment plans is that it cannot be used when AMR-WB capable mobile is roaming in a 2G radio network without hacking the standard TFO logic in the MGW. This use case is shown in FIG. 7 as a comparative example 4 where the AMR-WB capable mobile calls a non-AMR-WB capable mobile or PSTN.

Specifically, FIG. 7 shows how BWE cannot be used although the calling party has an AMR-WB capable terminal and BSS supports AMR TFO. This restriction hurts the attractiveness of BWE and must somehow be solved. The reason why BWE cannot be used with 2G calls is that BWE cannot be placed on the calling side MGW because the A-interface codec is G.711 (narrow band) and the circuit switched core network side codec is AMR-NB (narrow band). BWE requires that one of the codecs is AMR-WB which clearly cannot be the case with the current codec negotiation.

FIG. 8 shows an exemplary implementation of the present invention according to certain embodiments thereof as an example 4 which solves the restriction of BWE usage in 2G calls.

The benefit of these certain embodiments of the present invention can been seen in FIG. 8 when compared with FIG. 7. The AMR-WB capable subscriber still has the HD voice experience although he/she is roaming in 2G. Additionally, the standard AMR TFO functionality can be used on the 2G side and no proprietary hacking is needed. BWE functionality is pushed to the remote edge via the enhanced codec negotiation, and AMR-WB can be selected for the backbone. Local codec transparency for the AMR-WB at the local side is provided by the standard AMR TFO.

Similarly, in all other call cases and supplementary services the location of BWE can be optimized by using standard codec negotiation enhanced according to further certain embodiments of the present invention. For simplicity, the above examples are described for cellular calls using AMR-WB, but the same principles apply for fixed VoIP and DECT terminals that use the ITU-T compliant G.722 wideband codec.

It is to be noted that these codec negotiation enhancements are also valid for mid call codec negotiation (MCCN), because the same codec negotiation procedure which is used in the call setup phase is also used with MCCN. This means in practice that BWE can be activated also during an ongoing call when a narrowband-narrowband call that has no BWE becomes a narrowband-wideband call after a mobility event like handover or supplementary service invocation (e.g. call forwarding).

According to certain embodiments of the present invention, BWE is never used in a narrowband to narrowband call so if BWE is supported in the network, then activation occurs only when all of the following conditions are true:
a) BWE is locally supported by MSS/MGW;
b) the MSS/MGW where BWE is activated has received AMR-WB as a direct codec from the distant side; and
c) a local codec transparency at MSS/MGW with wideband codec cannot be obtained.

Thus, the codec negotiation enhancements coupled with the above basic principles according to certain embodiments of the present invention provide full optimization of the BWE functionality in e.g. an MSC server system or VoIP based system using codec negotiation and HD voice.

According to other certain embodiments of the present invention it is considered that when BWE is used on the network side, an operator can provide WB speech coverage throughout the network, whereas BWE in the terminal would allow WB speech only for those end users that happen to own an BWE capable phone. Also an operator may not be able to control the quality of BWE algorithms used in terminals. Thus, it is clearly desirable for operators that BWE is run on the network side.

However, the problem of using BWE in the network (typically alongside with WB speech codec within MGW or 2G transcoder) is additionally required resources due to the high computational complexity of WB speech codec and BWE. Typically, WB codec plus BWE can be two to three times computationally more complex than running a conventional NB speech codec. Thus, this can significantly affect the channel capacities in the MGW.

Accordingly, there can be a need to have a solution for the channel capacity decrease with BWE feature used on the network side.

If BWE is run in the terminal instead of the network a conventional NB codec will be used in the network and no additional resources are required in the network. However, this solution does not offer a network-wide coverage as not all terminals include the BWE feature (current standards do not require it). Furthermore, the quality of BWE may not be high enough in some terminals, because it is quite challenging to design a high quality BWE algorithm.

If the network can detect WB terminals that include high quality BWE algorithm, it could allocate conventional NB codec for those terminals, instead of allocating WB codec plus BWE for WB-NB inter-working use cases. This results in a conventional end-to-end NB call. Only for non-BWE capable and possibly poor quality BWE terminals, WB codec would be allocated and BWE would be run on the network side. The more BWE capable terminals are available, the more resources can be saved in the network, e.g. in MGW.

According to certain embodiments of the present invention, the BWE capable terminal identification is based on the terminal IMEI code. As soon as the network receives the IMEI from the terminal, it can check if the particular terminal model is BWE capable based on a pre-known BWE capable terminal model list. In case of possible WB-NB call and if the terminal is BWE capable, NB call will be established instead of WB-NB transcoding and BWE.

Accordingly, when an NB-WB inter-working is possible, the MSC or MSS analyses whether the WB capable terminal supports BWE feature. If it supports BWE, a conventional NB call is allocated towards the WB capable terminal. On the other hand, if BWE is not supported by the WB terminal or if the quality of BWE is not high enough, WB codec is allocated towards the WB terminal and NB-WB transcoding via BWE functionality is allocated on the network side.

An example procedure is shown in the flow chart of FIG. 10. In the first step, the MSC/MSS analyses whether an end-to-end WB call is possible. This is done during the codec negotiation when the calling and called terminals send the codec list to the MSC/MSS. If both terminals support WB codec (e.g. AMR-WB), WB codec will be allocated to both terminals and the native WB call will be established.

In the second step the MSC/MSS analyses whether NB-WB inter-working is possible. If it is not possible (i.e. both terminals support only NB codec or codecs, or the network supports only NB codecs), NB codecs will be allocated to both terminals and a conventional NB call will be established.

If only one terminal supports WB codec (e.g. AMR-WB), then NB-WB inter-working is possible. Next, in the third step, the MSC/MSS checks if the IMEI or IMEISV code for the WB terminal is available. If it is not available, the MSC/MSS will inquire it from the WB terminal by using the layer 3 (L3) identity request procedure specified by 3GPP.

Once the IMEI or IMEISV code is available, the MSC/MSS checks in the step four by utilizing service attribute analysis (SAA) if the WB capable terminal supports BWE. The MSC/MSS has a list of BWE supported terminal models. The terminal model can be deduced from the type allocation code (TAC) field of IMEI or IMEISV.

If the WB capable terminal supports BWE, a conventional NB codec will be allocated to the WB terminal and NB transcoding or TrFO/TFO resources will be reserved from the MGW, enabling the minimum resource consumption in the MGW while still providing BWE functionality by the WB capable terminal.

On the other hand if the WB capable terminal does not support BWE or the quality of BWE is known as being too low, the MSC/MSS will allocate WB codec to the WB capable terminal and it will reserve resources for NB-WB transcoding and BWE from the MGW. In this case, the BWE functionality is provided by the network (e.g. MGW).

According to further certain embodiments of the present invention, the above IMEI based implementation can be combined with the negotiation procedure described earlier.

Specifically, as mentioned above, as the BWE function consumes some additional capacity in the DSPs of the MGW it is desirable that in cases where the terminal internally supports BWE functionality, the network BWE is not used.

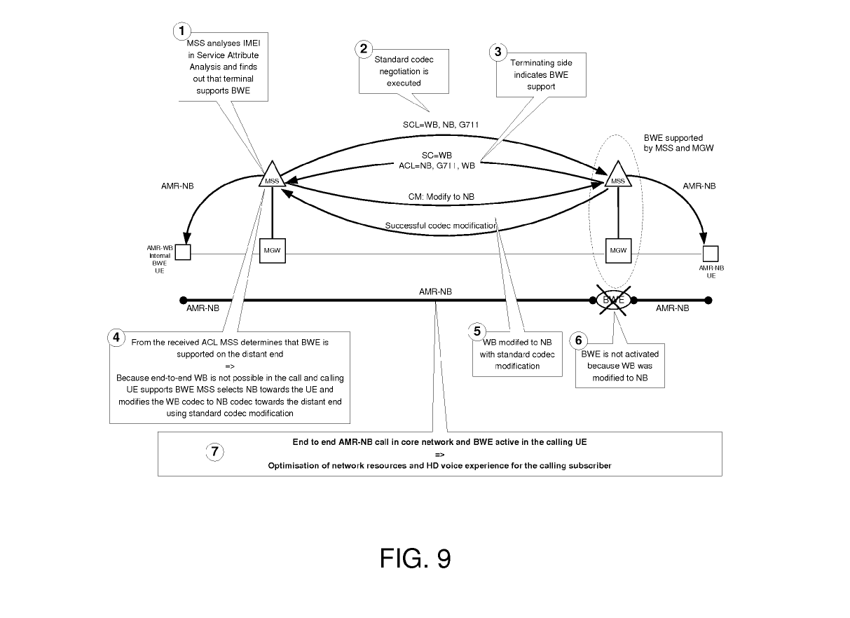

Thus, according to certain embodiments of the present invention, the IMEI based control for BWE can be flexibly supported as shown by FIG. 9.

Specifically, at first the MSS analyses the IMEI of the attached UE in SAA and finds out that terminal supports BWE. Second, the standard codec negotiation is executed. Third the terminating side indicates BWE support. Fourth, from the received ACL the MSS determines that BWE is supported on the distant end, but because end-to-end WB is not possible in the call and the calling UE supports BWE, the MSS nevertheless selects NB towards the UE and modifies the WB codec to NB codec towards the distant end using standard codec modification. Fifth, the WB is modified to NB with standard codec modification. Sixth the BWE is not activated because WB was modified to NB. Seventh, an end to end AMR-NB call in the core network is established and BWE is active in the calling UE with the result of an optimization of network resources and HD voice experience for the calling subscriber.

That is, if the BWE capable terminal is a called party the same codec negotiation and codec modification procedure is used to bypass network BWE and provide BWE functionality in the called UE. Thus, with IMEI control BWE can be placed either in the terminal or the network according to terminal capabilities.

As indicated above, implementation examples for certain embodiments of the present invention include MSS equipment capable of BWE usage optimization such as 2G/3G MSS, but are not limited thereto.

According to the above description, it should thus be apparent that exemplary embodiments of the present invention provide, for example from the perspective of a network element such as a MSS or a component thereof, an apparatus embodying the same, a method for controlling and/or operating the same, and computer program(s) controlling and/or operating the same as well as mediums carrying such computer program(s) and forming computer program product(s).

For example, described above are apparatuses, methods and computer program products capable of base station aided synchronization to a base station of higher hierarchical level.

Implementations of any of the above described blocks, apparatuses, systems, techniques or methods include, as non limiting examples, implementations as hardware, software, for example in connection with a digital signal processor, firmware, special purpose circuits or logic, general purpose hardware or controller or other computing devices, or some combination thereof.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1-27. (canceled)

28. An apparatus, comprising:
a codec negotiation means configured to negotiate codecs to be used in a communication connection between communication network nodes, and to indicate, in negotiation, a capability of a communication network node to expand bandwidth by indicating support of the communication network node for a wideband codec towards another communication network node, and indicating a lacking of codec transparency for the wideband codec at the communication network node.

29. The apparatus according to claim 28, wherein said codec negotiation means is configured to indicate a capability of the communication network node to expand bandwidth by further indicating a capability of the communication network node to provide narrowband-wideband transcoding.

30. The apparatus according to claim 28, wherein said codec negotiation means is configured to indicate a support of the communication network node for the wideband codec towards the another communication network node and the lacking of codec transparency for the wideband codec at the communication network node by including the wideband codec in a category of indirect codecs in a codec negotiation list for use in a communication node codec negotiation.

31. The apparatus according to claim 29, wherein said codec negotiation means is configured to indicate the capability of the communication network node to provide the narrowband-wideband transcoding by at a same time including the wideband codec in a category of indirect codecs and including a narrowband codec in a category of direct codecs in a codec negotiation list for use in a communication node codec negotiation.

32. An apparatus, comprising:
detection means configured to detect via an interface connection a capability of a terminal to expand bandwidth.

33. The apparatus according to claim 32, wherein said detection means is configured to detect an international mobile station equipment identity of the terminal and to identify a bandwidth expansion capability of the terminal based on a look-up table listing international mobile station equipment identities corresponding to the bandwidth expansion capability.

34. The apparatus according to claim 32, further comprising:
a codec negotiation means configured to negotiate codecs to be used in a communication connection between communication network nodes; and
a bandwidth expansion capability activation means configured to activate a bandwidth expansion capability.

35. The apparatus according to claim 34, wherein, for responding to said detection means detecting the terminal has the bandwidth expansion capability in the communication connection for which a codec is to be negotiated, said codec negotiation means is configured to perform a narrowband codec selection process for the communication connection, and said bandwidth expansion capability activation means is configured to activate the bandwidth expansion capability in the terminal.

36. The apparatus according to claim 34, wherein, for responding to said detection means detecting the terminal has the bandwidth expansion capability in the communication connection for which a codec is to be negotiated, said codec negotiation means is configured to perform a codec modification process which modifies a wideband codec as a negotiated codec to a narrowband codec as the negotiated codec, and said bandwidth expansion capability activation means is configured to activate the bandwidth expansion capability in the terminal.

37. The apparatus according to claim 34, wherein, for responding to said detection means detecting the terminal not having the bandwidth expansion capability or has insufficient bandwidth expansion capability in the communication connection for which a codec is to be negotiated, said codec negotiation means is configured to perform a wideband codec selection process for the communication connection, and said bandwidth expansion capability activation means is configured to activate the bandwidth expansion capability in a communication network node.

38. A mobile services switching center server system, comprising:
an apparatus having a codec negotiation means configured to negotiate codecs to be used in a communication connection between communication network nodes, and to indicate, in negotiation, a capability of a communication network node to expand bandwidth by indicating support of the communication network node for a wideband codec towards another communication network node, and indicating a lacking of codec transparency for the wideband codec at the communication network node.

39. A communication node system, comprising:
a first apparatus having a codec negotiation means configured to negotiate codecs to be used in a communication connection between communication network nodes, and to indicate, in negotiation, a capability of a communication network node to expand bandwidth by indicating support of the communication network node for a wideband codec towards another communication network node, and indicating a lacking of codec transparency for the wideband codec at the communication network node, said codec negotiation means further configured to indicate the capability of the communication network node to provide narrowband-wideband transcoding by at a same time including the wideband codec in a category of indirect codecs and including a narrowband codec in a category of direct codecs in a codec negotiation list for use in a communication node codec negotiation; and
a second apparatus having a detection means configured to detect via an interface connection a capability of a terminal to expand bandwidth, a further codec negotiation means configured to negotiate codecs to be used in the communication connection between the communication network nodes, and a bandwidth expansion capability activation means configured to activate a bandwidth expansion capability.

40. A method, which comprises the steps of:
negotiating codecs to be used in a communication connection between communication network nodes, wherein the negotiating containing indicating a capability of a communication network node to expand bandwidth by indicating support of the communication network node for a wideband codec towards another communication network node, and indicating a lacking of codec transparency for the wideband codec at the communication network node.

41. The method according to claim 40, wherein the negotiating step further comprises indicating a capability of the communication network node to expand the bandwidth by further indicating a capability of the communication network node to provide narrowband-wideband transcoding.

42. The method according to claim 40, wherein the negotiating steps further comprises indicating a support of the communication network node for the wideband codec towards the another communication network node and the lacking of codec transparency for the wideband codec at the communication network node by including the wideband codec in a category of indirect codecs in a codec negotiation list for use in a communication node codec negotiation.

43. The method according to claim 41, wherein the negotiating step further comprises indicating the capability of the communication network node to provide the narrowband-wideband transcoding by at a same time including the wideband codec in a category of indirect codecs and including a narrowband codec in a category of direct codecs in a codec negotiation list for use in a communication node codec negotiation.

44. A method, which comprises the step of:
detecting via an interface connection whether a terminal has capability to expand bandwidth.

45. The method according to claim 44, wherein the detecting step further comprises detecting an international mobile station equipment identity of the terminal and identifying a bandwidth expansion capability of the terminal based on a look-up table listing international mobile station equipment identities corresponding to a bandwidth expansion capability.

46. The method according to claim 44, which further comprises:
negotiating codecs to be used in a communication connection between communication network nodes; and
activating a bandwidth expansion capability.

47. The method according to claim 46, which further comprises:
responding to detecting that the terminal has the bandwidth expansion capability in the communication connection by performing a narrowband codec selection process for the communication connection; and
activating the bandwidth expansion capability in the terminal.

48. The method according to claim 46, further comprising responding to detecting that the terminal has the bandwidth expansion capability in the communication connection by performing a codec modification process which modifies a wideband codec as a negotiated codec to a narrowband codec as the negotiated codec, and activating the bandwidth expansion capability in the terminal.

49. The method according to claim 46, further comprising responding to detecting that the terminal does not have the bandwidth expansion capability or having insufficient bandwidth expansion capability in the communication connection by performing a wideband codec selection process for the communication connection, and activating the bandwidth expansion capability in a communication network node.

50. A method, which comprises the steps of:
negotiating codecs to be used in a communication connection between communication network nodes, wherein the negotiating containing indicating a capability of a communication network node to expand bandwidth by indicating support of the communication network node for a wideband codec towards another communication network node, and indicating a lacking of codec transparency for the wideband codec at the communication network node, wherein the negotiating steps further comprises indicating a support of the communication network node for the wideband codec towards another communication network node and the lacking of codec transparency for the wideband codec at the communication network node by including the wideband codec in a category of indirect codecs in a codec negotiation list for use in a communication node codec negotiation;
detecting via an interface connection whether a terminal has capability to expand bandwidth;
negotiating codecs to be used in a communication connection between the communication network nodes; and
activating the bandwidth expansion capability.

51. A computer program product containing non-transitory computer-executable instructions to be ran on a computer and performing a method which comprises the steps of:
negotiating codecs to be used in a communication connection between communication network nodes, wherein the negotiating indicating a capability of a communication network node to expand bandwidth by indicating support of the communication network node for a wideband codec towards another communication network node; and
indicating a lacking of codec transparency for the wideband codec at the communication network node.

52. The computer program product according to claim 51, wherein the computer program product is stored on a non-transitory computer-readable storage medium.

53. A computer program product containing non-transitory computer-executable instructions to be ran on a computer and performing a method which comprises the step of:
detecting via an interface connection whether a terminal has capability to expand bandwidth.

54. The computer program product according to claim 53, wherein the computer program product is stored on a non-transitory computer-readable storage medium.
